(19) United States
(12) Patent Application Publication
(10) Pub. No.: US 2026/0298675 A1
(43) Pub. Date: Oct. 1, 2026

(54) DEVICE, METHOD AND SYSTEM FOR QUANTIFYING A CHANGE IN ENVIRONMENTAL CONDITIONS ALONG THE LENGTH OF AN OPTICAL FIBER

(71) Applicant: Bundesrepublik Deutschland, vertreten durch den Bundesminister Für Wirtschaft und Klimaschutz,, Berlin (DE)

(72) Inventor: Xin Lu, Braunschweig (DE)

(21) Appl. No.: 19/483,462

(22) PCT Filed: May 8, 2024
(86) PCT No.: PCT/EP2024/062780

§ 371 Date: Nov. 11, 2025

(30) Foreign Application Priority Data
May 12, 2023 (DE) 10 2023 112 656.3

(51) Int. Cl. G01D 5/353; G01K 11/3206; G01L 1/24

(52) U.S. Cl. CPC G01D 5/35361; G01D 5/35325; G01D 5/35329; G01K 11/3206; G01L 1/242

(57) ABSTRACT

A device (100) for quantifying a change in environmental conditions along the length of an optical fiber (130) includes a frequency-scanning optical pulse generator (110) to generate pulse sequences of optical pulses; an optical component (120) coupled with the pulse generator (110) to inject the optical pulses into an optical fiber (130) and to redirect the backscattered optical signal from the optical fiber (130); and a receiver module (150) coupled with the optical component (120). The receiver module (150) includes an interferometer (170) for determining phase information of the backscattered optical signal as a function of time and optical frequency.

### BACKGROUND

A distributed optical fiber sensing (DOFS) system employs an optical fiber as a sensing element for sensing environmental changes. Such systems allow seamless and spatially resolved measurements along the fiber. A phase-sensitive optical time domain reflectometry (φOTDR) is such a sensing system and is based on the Rayleigh scattering inside the optical fiber. When a series of interrogating optical pulses is launched into the optical fiber, the light is backscattered at randomly distributed inhomogeneities of the fiber material. The backscattered optical signal is a fingerprint of the optical fiber which changes when the fiber is subjected to environment variations such as temperature changes or mechanical stress. In recent years, this sensing system has been widely applied to many areas, such as structural health monitoring, intrusion surveillance and seismic events detection.

A φOTDR system injects coherent optical pulses into a sensing fiber and records the Rayleigh backscattered light of the pulses as a function of time. The obtained signal in time domain can be converted into distance based on the time-of-flight of the light. The environmental variation can modify the properties of the local fiber, such as refractive index and fiber section size, so the amplitude/intensity and the phase of light backscattered from the corresponding location are changed. The environmental variation can be quantified based on the change of amplitude/intensity or optical phase.

DE 10 2018 105 905 B4 and Liehr et al. “Wavelength-scanning coherent OTDR for dynamic high strain resolution sensing” Optics Express Vol. 26, Issue 8, pp. 10573-10588 (2018) describe a method based on the change of amplitude/intensity of the backscattered light. The optical frequency of the interrogating optical pulses is periodically changed to obtain a reflection spectrum. A change of the fiber environment causes a shift of the reflection spectrum, which shift can be detected. This method allows to measure environmental changes at a very low frequency (quasi-static) as the maximum measurable frequency is greatly limited by the scanning speed. A similar method is disclosed in US 2010/0 014 071A1.

On the other hand, there are generally two methods to obtain the phase of the backscattered light in a φOTDR system. One method, as described in U.S. Pat. No. 9,170,149 B2, is coherent detection: the backscattered light is mixed with a local oscillator, their beat signal is detected and processed to obtain the phase information. The other method is based on different types of interferometric structures, which convert the phase information into optical intensity. The output of the interferometer is recorded by direct detection and the obtained signal is processed to retrieve the optical phase information. See, for example, A. Masoudi et al.: “A distributed opticalfibre dynamic strain sensor based on phase-OTDR”, Measurement Science and Technology, volume 24 (2013), 085204; US 2021/0 033 430 A1, and X. Lu et al.: “Evaluating phase errors in phase-sensitive optical time-domain reflectometry based on I/Q demodulation”, Journal of Lightwave Technology, Volume 38, No. 15, (2020), 4133-4141. The above described phase-based φOTDR systems can reach a very high frequency that is limited by the length of the sensing fiber, but it suffers from different noise to measure the environmental change at low frequency. As a result, advanced signal processing is required for denoising in order to realize low frequency measurement as, for example, explained in US 2017/0 342 814 A1.

Based on current φOTDR systems, only one characteristic of the backscattered light, for example either intensity/amplitude or optical phase, can be determined and used for distributed measurement. However, the obtained characteristic is sensitive to many environmental parameters, such as strain and temperature, and it is very difficult to discriminate two environmental parameters based on a single characteristic of the backscattered light. For example, the cross sensitivity has a negative influence on the strain sensing at low frequency in practice because the temperature variation over time can also change the obtained characteristic of the backscattered light, introducing an error. Additional sensing fibers or sensing systems are needed to compensate the influence of the temperature change. As described in Z. Ding et. al: “Distributed Strain and Temperature Discrimination Using Two Types of Fiber in OFDR”, IEEE Photonics Journal, Volume 8, No. 5, (2016), Art no. 6804608, two different types of optical fibers can be used to discriminate temperature and strain changes based on the reflection spectrum shift. Or two distributed fiber sensing systems, such as φOTDR system and a distributed temperature sensing system, can be used to simultaneously measure temperature and strain change, as described in R. Amer et al.: “Field Applications of Distributed Fiber Optic Strain and Temperature Sensing for Caprock—Well Integrity and CO₂ Leakage Monitoring”, Proceedings of the 16^{th} Greenhouse Gas Control Technologies Conference (GHGT-16) 23-24, Oct. 2022. Consequently, the total sensing system is complex and expensive.

Attempts have been made to measure both the intensity and the phase of the backscattered light as, for example, mentioned in US 2017/0 342 814 A1 referred to above. However, the configuration disclosed in US 2010/0 014 071 A1 needs coherent detection to obtain the phase information, which requires very high coherence of the light source for long distance sensing.

Hence, there is need to expand the frequency sensing range and discriminate between strain and temperature changes for both high- and low-frequency measurements of environmental parameters of interest.

### SUMMARY

In view of the above, a device for quantifying a change in environmental conditions along the length of an optical fiber is suggested. The device allows the determination of two characteristics of the reflected optical signal by employing a new configuration for the interrogating device so that at least two environmental parameters effecting the physical properties of the optical fiber can be measured. In particular, the phase and the intensity/amplitude of the backscattered optical signal can be determined which allows to measure reliably both high-frequent environmental changes, such as vibrations and strains, and low-frequent environmental changes such as temperature changes. The device, coupled with an optical fiber, provides a distributed optical fiber sensing (DOFS) system.

The system and methods as described herein are based on both phase and amplitude/intensity of Rayleigh backscattered light. The system launches frequency-scanning optical pulses into an optical fiber (sensing fiber) and detects backscattered light (backscattered optical signals) from the fiber. The correlation of the amplitude/intensity of the backscattered light obtained during the scanning along the optical fiber provides a quantity of spectral shift that can be used for low frequency measurement. A phase difference is calculated based on outputs of an interferometer in the sensing system, which can be used for high frequency measurement. The phase difference obtained from a fiber section that is isolated from environmental perturbations can also be used to determine the relative frequency change during the scanning. A combination of the obtained spectral shift and the phase difference enables to determine changes of two parameters of interest.

A device for quantifying a change in environmental conditions along the length of an optical fiber, a system including an optical fiber and device for quantifying a change in environmental conditions along the length of the optical fiber, and methods are disclosed herein and provided to solve the above.

According to an embodiment, a device for quantifying a change in environmental conditions along the length of an optical fiber includes a frequency-scanning optical pulse generator, an optical component, and a receiver module which includes an interferometer, photo detectors and a data processing device. The frequency-scanning optical pulse generator is configured to generate pulse sequences of optical pulses with variable optical frequencies. The optical component is coupled with the frequency-scanning optical pulse generator for injecting the optical pulses into an optical fiber and for redirecting the backscattered optical signal from the optical fiber. The receiver module is coupled with the optical component. The interferometer of the receiver module has an input for receiving the backscattered optical signal and a coupler for providing optical signal outputs with shifted phases, wherein each optical signal output of the coupler is coupled with one of the photo detectors for providing electrical signals. The data processing device is coupled with the photo detectors for receiving the electrical signals. The data processing device is configured to derive phase information of the backscattered optical signal from the electrical signals as a function of time and optical frequency.

Using an interferometer allows detecting the phase of the backscattered optical signal with high reliably. The interferometer provides optical signal outputs with shifted phases relative to each other, so that when using suitable demodulation processing methods, such as IQ demodulation, differentiation and cross-multiplication algorithm, the phase of the backscattered signal or the phase difference of the backscattered light along the optical fiber can be obtained.

In a simple configuration, the interferometer has two optical outputs with a shifted phase of, for example, 120°. The photo detectors may be arranged to form a balanced detector. In expanding this configuration, the interferometer has three outputs with a shifted phase of, for example, 120° with each optical output of the interferometer coupled with a respective photo detector.

The frequency-scanning optical pulse generator provides coherent pulses so that the backscattered optical signals can interfere in the interferometer.

According to an embodiment, which can be combined with any other embodiment described herein, the data processing device is configured to derive, in addition to phase information, amplitude and/or intensity information of the backscattered optical signal from the electrical signals as a function of time and optical frequency. The amplitude and/or intensity information can be obtained from evaluating the electrical signals provided by the photo detectors. Phase and amplitude/intensity information can be simultaneously determined.

As only one optical source is needed for the determination of the phase and the amplitude/intensity, the device is cost efficient and space-saving.

According to an embodiment, which can be combined with any other embodiment described herein, the frequency-scanning optical pulse generator is configured to periodically or repeatedly scan the optical frequency of the optical pulses through a predetermined optical frequency range. When repeatedly scan the optical frequency to generate a plurality of sequences of optical pulses, each sequence can be used to obtain a reflection spectrum. Changes in the reflection spectrum such as a shift in the reflection spectrum may be used as parameter to quantify an environmental change (parameter of interest). An example are temperature variations.

According to an embodiment, which can be combined with any other embodiment described herein, the frequency-scanning optical pulse generator comprises a coherent light source configured to receive an electric driver signal which causes the light source to perform optical frequency scanning, and an optical gate configured to receive light from the light source and to generate optical pulses. The driver signal may be provided by a driver to repeatedly or periodically scan the optical frequency. A linear change of the optical frequency within a sequence of pulses, with the optical frequency for an individual optical pulse remaining constant, are beneficial for determining the spectral shift based on the amplitude/intensity information. The optical frequency of a single optical pulse can be considered to be constant as the optical frequency scanning rate is very low, in kHz or sub-kHz range and the optical scanning range is comparatively small, e.g. a few GHz. Considering a typical pulse duration (a few tens of ns), the optical frequency within the duration of a pulse can be approximated as a constant.

According to an embodiment, which can be combined with any other embodiment described herein, the frequency-scanning optical pulse generator comprises a coherent light source configured to operate at a fixed optical frequency, a modulator configured to be driven by a RF signal with a scanned microwave frequency, an optional narrow filter to select one sideband after the modulation for optical frequency scanning, and an optical gate for optical pulse generation. The modulator generates sidebands of the light generated by the frequency-scanning optical pulse generator, for example by amplitude modulation using microwave frequency. The narrow filter selects the desired sideband. However, the narrow filter is optional when the modulator creates only one sideband or when the modulator already suppresses unwanted sidebands.

According to an embodiment, which can be combined with any other embodiment described herein, the frequency-scanning optical pulse generator comprises a coherent light source configured to operate at a fixed optical frequency, a modulator configured to be driven by a RF pulse signal and an optional narrow filter to select one sideband after the modulation for optical frequency scanning.

According to an embodiment, which can be combined with any other embodiment described herein, the receiver module is configured to determine the relative optical frequency v′ of the injected optical pulses relative to a reference optical frequency during scanning based on the optical signal backscattered from the reference section of the optical fiber. For detecting the phase and amplitude, particularly for obtaining reflection spectra, a linear change of the optical frequency of the pulses is desired. Detecting the optical frequency v′ of the injected optical pulses relative to a reference optical frequency during scanning provides for a feedback option to adjust the driver signal supplied to the frequency-scanning optical pulse generator, particularly to the light source. Alternatively or additionally, the detected optical frequency v′ of the injected optical pulses may be used to interpolate the obtained reflection spectrum, for example when the optical frequency was not linearly changed. Overall, the reflection spectra can be more reliably determined as information on the actually emitted optical frequency is obtained.

For detecting the optical frequency v′ of the injected optical pulses, optical signals backscattered from a reference section of the optical fibers can be used. The reference section is kept at defined and constant environmental conditions.

According to an embodiment, which can be combined with any other embodiment described herein, the receiver module is configured to obtain reflection spectra for a given position in the optical fiber based on sequences of pulses, wherein the receiver module is further configured to detect a frequency shift of the reflection spectra to acquire the local environmental information.

According to an embodiment, which can be combined with any other embodiment described herein, the interferometer comprises two arms with different path lengths, wherein the difference between the two arms is equal to or larger than the length of an optical pulse.

According to an embodiment, which can be combined with any other embodiment described herein, the receiver module comprises a splitter for splitting the backscattered optical signal into two optical split signals, a submodule for determining amplitude and/or intensity information of the backscattered optical signal, and a submodule for determining phase information of the backscattered optical signal. The submodule for determining amplitude and/or intensity information is coupled with the splitter to receive one optical split signal of the backscattered optical signal, and the submodule for determining phase information is coupled with the splitter to receive the other optical split signal of the backscattered optical signal.

The receiver module may therefore include two optical branches, one for the determination of the amplitude/intensity and another for the determination of the phase. This provides for more options in operating the device. For example, if for a certain time only information about the amplitude/intensity is desired, for example to obtain the reflection spectra allowing determination of low-frequency environmental changes, then only one branch, i.e. only one submodule may be operative. This reduces the amount of generated data and thus eases the data processing.

According to an embodiment, which can be combined with any other embodiment described herein, the submodule for determining amplitude and/or intensity information comprises a coupler for mixing the optical split signal with a local oscillator and a balanced detector for detecting the output of the coupler. The balanced detector may comprise two photo detectors. A beat signal of the mixed optical split signal and the signal from the local oscillator is detected.

According to an embodiment, which can be combined with any other embodiment described herein, the submodule for determining phase information comprises the interferometer and the photo detectors for detecting the output of the interferometer.

The interferometer may include two arms with one arm introducing a delay of Δl. It is noted that a longer optical path corresponds to a delay as path and time are coupled by the light velocity. The signal provided by the interferometer can thus be described as being proportional to E(vᵢ,z,tₘ)*E(vᵢ,z+Δl,tₘ), with z representing a position in the optical fiber and vᵢ being the optical frequency of the pulse. The time tₘ represents here the time at which the measurement was performed. For obtaining a single reflection spectrum for optical frequencies from v₁ to vₚ, it is assumed that the parameter of interest changes at a low frequency and can be considered to remain constant over the time period needed for taking one single reflection spectrum. A change of the parameter of interest, such as the temperature, can be detected by comparing reflection spectra taken at tₘ and t_{m+q} for example.

According to an embodiment, which can be combined with any other embodiment described herein, the interferometer comprises a first arm and a second arm, wherein the first arm has a longer optical path than the second arm. The coupler is a [3×3] coupler which is configured to output three optical signals with shifted phases of 120°, wherein the first arm and the second arm are coupled with respective inputs of the [3×3] coupler. Each optical signal output of the [3×3] coupler is coupled with one of the photo detectors for providing the electrical signals. The first arm introduces an optical delay as explained above.

According to an embodiment, which can be combined with any other embodiment described herein, the phase difference Δφ along the reference section and the sensing section and the amplitude information A_{de}(z) is determined according to

$$\{ \begin{matrix}I ( z ) = - {P}_{1} ( z ) / 2 + {P}_{2} ( z ) - {P}_{3} ( z ) / 2 \\ Q ( z ) = - \sqrt{3} {P}_{1} ( z ) / 2 + \sqrt{3} {P}_{3} ( z ) / 2\end{matrix}$$

$$and$$

$${A}_{de} ( z ) ∝ \sqrt{{1}^{2} ( z ) + {Q}^{2} ( z )}$$

$$Δ φ ( z ) = {tan}^{- 1} [ I ( z ) / Q ( z ) ] + 2 k π$$

wherein P₁(z), P₂(z) and P₃(z) denote the signals obtained and produced by the photo detectors, respectively, and wherein k is an integer and the term 2kπ represents a phase unwrapping process to expand the value of the tan⁻¹ function.

According to an embodiment, which can be combined with any other embodiment described herein, a system for quantifying a change in environmental conditions along the length of an optical fiber includes a device according to any of the embodiments described herein, and an optical fiber coupled with the optical component of the device. The device coupled with an optical fiber forms an operative distributed optical fiber sensing (DOFS) system based on phase-sensitive optical time domain reflectometry (φOTDR).

According to an embodiment, which can be combined with any other embodiment described herein, the optical fiber comprises a reference section that is isolated from environmental perturbations and a sensing section. The reference section may be used for detecting the optical frequency v′ of the injected optical pulses as described above. The sensing section may be used to detect the environmental parameter(s) of interest.

According to an embodiment, which can be combined with any other embodiment described herein, a method for determining changes of parameters of interest along the optical fiber for low and high frequency measurement includes the processes of: providing optical pulses of different optical frequencies; injecting the optical pulses into an optical fiber; receiving an optical signal Rayleigh backscattered from the optical fiber; splitting the optical signal into two optical split signals; detecting one of the two optical split signals as intensity of the backscattered optical signal as a function of time to obtain reflection spectra along the optical fiber; introducing the other of the two optical signals into an interferometer and detecting the output of the interferometer as a phase of the optical signal backscattered from the optical fiber as a function of time; and calculating a spectral frequency based on correlation of the reflection spectrum along the optical fiber for low frequency measurement and a phase difference based on the output of the interferometer for high frequency measurement.

In this embodiment, the backscattered light is split, the intensity is directly obtained and the phase, or phase difference, is determined by using the interferometer. Low frequent changes of environmental changes are determined using a correlation between reflection spectra, while high frequent changes are determined using the phase difference.

According to an embodiment, which can be combined with any other embodiment described herein, a method for determining changes of parameters of interest along the optical fiber for low and high frequency measurement includes the processes of: providing optical pulses of different optical frequencies; injecting the optical pulses into an optical fiber; receiving an optical signal Rayleigh-backscattered from the optical fiber which is introduced into an interferometer; detecting the output of the interferometer as a function of time; calculating amplitude information A_{de} and phase difference of the backscattered optical signal based on the output of the interferometer and obtain reflection spectra based on the amplitude information A_{de}; and calculating a spectral frequency based on correlation of the reflection spectrum and amplitude information A_{de} for low frequency measurement and the obtained phase difference for high frequency measurement.

According to this embodiment, the backscattered light is not split and the interferometer is used to determine both the amplitude (or intensity) and the phase difference. A direct determination of the intensity by a separate submodule is not needed. The reflection spectra are determined using the amplitude. Low frequent changes of environmental changes are determined using a correlation between reflection spectra, while high frequent changes are determined using the phase difference.

According to an embodiment, which can be combined with any other embodiment described herein, a method for determining changes of parameters of interest along the optical fiber based on the spectral shift and the phase difference includes the processes of: providing optical pulses of different optical frequencies; injecting the optical pulses into an optical fiber; receiving an optical signal Rayleigh backscattered from the optical fiber; splitting the optical signal into two optical split signals; detecting one of the two optical split signals as intensity of the backscattered optical signal as a function of time to obtain reflection spectra along the optical fiber; introducing the other of the two optical signals into an interferometer and detecting the output of the interferometer as a phase of the optical signal backscattered from the optical fiber as a function of time; calculating a spectral frequency based on correlation of the reflection spectrum along the optical fiber and a phase difference based on the output of the interferometer; and calculating the change of the two parameters of interest based on the spectral frequency and the phase difference.

In this embodiment, the backscattered light is split, the intensity is directly obtained and the phase, or phase difference, is determined by using the interferometer. The reflection spectra are determined using the intensity. Changes of two environmental parameters are determined based on the spectral frequency, obtained based on the correlation of the reflection spectra, and the phase difference.

According to an embodiment, which can be combined with any other embodiment described herein, a method for determining changes of parameters of interest along the optical fiber based on the spectral shift and the phase difference includes the processes of: providing optical pulses of different optical frequencies; injecting the optical pulses into an optical fiber; detecting the output of the interferometer as a function of time; calculating amplitude information A_{de} and phase difference of the backscattered optical signal based on the output of the interferometer and obtain reflection spectra based on the amplitude information A_{de}; calculating a spectral frequency based on correlation of the reflection spectrum and amplitude information A_{de}; and calculating the change of the two parameters of interest according to an equation system based on the spectral frequency and the phase difference.

According to this embodiment, the backscattered light is not split and the interferometer is used to determine both the amplitude and the phase difference. A direct determination of the intensity by a separate submodule is not needed. Changes of two environmental parameters are determined based on the spectral frequency, obtained based on the correlation of the reflection spectra, and the phase difference.

According to an embodiment, which can be combined with any other embodiment described herein, a method for determining changes of parameters of interest along the optical fiber based on the spectral shift and the phase difference includes the processes of: providing optical pulses at preselected optical frequencies, wherein one of the optical pulses is a reference pulse at a given optical frequency; injecting the optical pulses into an optical fiber comprising a reference section and a sensing section, wherein the reference section is kept at defined and constant environmental conditions; receiving optical signals Rayleigh-backscattered from the reference section of the optical fiber for each pulse, wherein the optical signals are introduced into an interferometer; detecting the output of the interferometer as a function of time; calculating a phase difference at the reference section of the optical fiber based on the output of the interferometer; and calculating the relative change of optical frequency relative to the given optical frequency of the reference pulse based on the obtained phase difference.

According to this embodiment, the change of optical frequency of the pulses relative to the optical frequency of a reference pulse can be determined. This can be used either as feedback for driving the frequency-scanning optical pulse generator including the coherent light source, or to interpolate the optical frequency when determining the reflection spectra. The determination of the change optical frequency of the pulses can be used in combination with any of the above-mentioned method.

Moreover, any of the above-mentioned methods can be performed using the device and system disclosed herein.

### BRIEF DESCRIPTION OF THE DRAWINGS

In the following, embodiments are described with reference to the drawings without being limited thereto.

FIG. 1 shows a schematic illustration of a basic embodiment used for distributed fiber sensing using optical pulses with scanned optical frequency.

FIG. 2 shows a schematic illustration of an exemplary embodiment based on two submodules for optical phase and amplitude/intensity detection, respectively.

FIG. 3 shows a schematic illustration of another exemplary embodiment based on a single submodule to simultaneously detect optical phase and amplitude/intensity.

FIG. 4 shows possible implementations of the submodule for amplitude/intensity detection, where FIG. 4(a) shows a schematic illustration based on direct detection and FIG. 4(b) shows a schematic illustration based on coherent detection.

FIG. 5 shows a schematic illustration of an exemplary embodiment of a submodule for optical phase detection, which can also be used as the submodule for phase and amplitude/intensity detection.

FIG. 6 shows an exemplary experimental setup to demonstrate an embodiment of the present invention, based on embodiment shown in FIG. 3.

FIG. 7 shows an optical phase difference obtained at one position of the reference section of the optical fiber and the calculated relative optical frequency change of the light source.

FIG. 8 shows an optical phase difference obtained at one sensing section of the optical fiber subjected to vibration, where FIG. 8(a) and FIG. 8(b) show the unfiltered and filtered phase difference over time.

FIG. 9 shows cross-correlation result of the reflection spectra obtained at one sensing section of the optical fiber subjected to vibrations.

FIG. 10 shows the spectral shifts obtained at one unperturbed position (1391.30 m) and one position (1407.65 m) of the sensing section of the optical fiber subjected to vibrations.

### DETAILED DESCRIPTION

The present disclosure provides a new device, method and system to measure or determine the change of a parameter or parameters of interest, for example temperature and strain, along a sensing fiber. The method is based on the reflection spectrum and the optical phase of the backscattered light that can be obtained by a single device such as a φOTDR device.

When referring to “light” or “light source” in the present disclosure, not only the visible light is meant but electromagnetic radiation, or a “light source” capable of generating electromagnetic radiation in the visible range and also in the non-visible range such as ultraviolet, near infrared and mid infrared range. A typical working range may be the near infrared between about 780 nm and 3 μm. For ease of explanation only, the term “light” or “light source” is used hereinafter without being limited to the visible light.

FIG. 1 shows a schematic illustration of a device 100, for example a φOTDR device, for quantifying a change in environmental conditions along the length of an optical fiber according to an embodiment.

The device 100 includes an optical frequency control or scanning of optical pulses embodied here by a frequency-scanning optical pulse generator 110, hereinafter referred to as pulse generator 110. The pulse generator 110 is coupled to an optical component 120 which is adapted to launch optical pulses generated by the pulse generator 110 into an optical fiber 130. The optical fiber 130 is also often referred to as fiber under test (FUT).

The pulse generator 110 is configured to generate optical pulse sequences at different optical frequencies. The generated pulses are coherent optical pulses. For example, a pulse sequence may comprise a plurality of pulses with varying optical frequency such as with increasing or decreasing optical frequency. In a typical application, all pulses of a pulse sequence have the same pulse width, i.e. duration. The distance between consecutive pulses may be such that the next pulse is generated after receiving the backscattered optical signal of the previous pulse so that consecutive pulses do not interfere with each other.

The optical element 120 serves mainly two purposes, namely to couple the optical pulses generated by the pulse generator 110 into the optical fiber 130 and to couple the backscattered optical signal of an optical pulse into a receiver module 150 which is coupled with the optical element 120. The optical element 120 can be, for example, a circulator, an optical coupler, or a fast optical switch.

The optical fiber 130, or fiber under test, is a fiber that can be coupled with the optical element 120 of the device, and may be replaceable by another optical fiber. Hence, the device 100 may be used with different fibers and may be coupled with a fiber 130 which is, for example, integrated in a building or an infrastructure object, such as a bridge, or a geological site such as a cavern for oil or gas storage. When coupled with an optical fiber 130, the device 100 forms together with the optical fiber 130 a system for quantifying a change in environmental conditions along the length of an optical fiber, i.e. a distributed optical fiber sensing (DOFS) system which can be embodied as φOTDR system.

According to an embodiment, the optical fiber 130 of the φOTDR system comprises a reference section 132 and a sensing section 131. The reference section 132 of the optical fiber 130 is kept under constant environmental conditions to isolate the reference section 132 from environmental changes. As the reference section 132 is not subjected to environmental perturbations, the optical signals backscattered from the reference section 132 can be used to determine the relative frequency change v′ of the optical pulses launched into the optical fiber 130. The sensing section 131 is used to acquire environmental changes, which influences physical properties of the optical fiber 130, to realize distributed sensing system.

As mentioned above, a φOTDR device acquires the Rayleigh backscattered signal along the optical fiber 130. Rayleigh scattering originates from the inhomogeneities in the optical fiber 130. The inhomogeneity scatters the light into all directions, a small portion of the scattered light is re-captured by the fiber 130 and propagates backwards, to the entrance of the incident light.

In a φOTDR system, coherent optical pulses are generated by the frequency-scanning optical pulse generator 110, injected into and propagating along the optical fiber 130. Each pulse is scattered continuously by the inhomogeneity during the propagation. The light backscattered within the half length of the pulse arrives at the receiver module 150 at the same time. Thus, the detected light at a given position z is the summation of the light backscattered at the inhomogeneities within the half pulse length.

The optical signal obtained in a φOTDR system is dependent on the optical frequency of the pulse and the scattering conditions. The property of the inhomogeneity, such as location, size, density and refractive index, vary randomly along the fiber. Thus, the scattering conditions are different at each fiber position. As a result, the detected backscattered light, i.e. the backscattered optical signal, for example the Rayleigh intensity trace, exhibits a stochastic profile along the fiber. This noise-like profile is static if the working condition remains constant, e.g. no temperature and strain variation and no optical frequency change of the incident pulses.

When there is a variance of the environmental condition and/or the optical frequency of the pulses, the scattering condition changes. As a result, the amplitude A(z), intensity |A(z)|² and phase φ(z) of the backscattered light change as well. The φOTDR device 100 retrieves the change of the amplitude, intensity or phase in order to quantify the environmental variation.

According to an embodiment, which can be combined with any other embodiment described herein, the φOTDR device 100 uses the frequency shift of the reflection spectrum at a given position in the optical fiber 130 to acquire the local environmental information. This technique sweeps the optical frequency of the pulse, thus creates a sequence of pulses with, for example, increasing optical frequency, and records a group of Rayleigh intensity traces for each frequency scan (sequence), which can be considered as a matrix in distance and optical frequency domain. At each fiber position, the obtained signal changes with the optical frequency, and this signal change is considered as the local reflection spectrum at the corresponding position. If the local environment changes, this spectrum shifts in the frequency domain compared with the previously obtained spectrum at the same position. The spectral shift Δv can be determined for example by cross correlating the two spectra. The environmental change can be quantified once the spectral shift is determined.

The spectral shift determining method typically employs a linear optical frequency scanning, so that the Rayleigh intensity trace is obtained at a uniform frequency step. In practice, a linear frequency scanning can be realized by RF modulation of the light, for which expensive and sophisticated equipment is needed. Direct modulation of the driving current of the light source, as employed here according to an embodiment which can be combined with any other embodiment described herein, is an economical solution to the optical frequency scan, but usually in a nonlinear manner. In this case, interpolation can be used if the optical frequency v can be determined during the scanning, so that the detected signal of the backscattered light can be reconstructed with a uniform frequency step. This method uses monitoring of the optical frequency change, for example by using the light backscattered from the reference section 132 of the optical fiber 130. Based on the optical frequency change, the reflection spectrum obtained at a given position after one frequency scanning can be interpolated in a way that the frequency step of the interpolated spectrum is uniform. A more detailed description of the detect spectrum interpolation is presented in S. Liehr et al.: “Wavelength-scanning coherent OTDR for dynamic high strain resolution sensing”, Optics Express, Volume 26, Issue 8, (2018), 10573-10588, which is incorporated herein by reference in its entirety.

Temperature and strain variations can cause the shift of the reflection spectrum, and the induced spectral shift can be expressed as

$$Δ {v}_{T} / v = - ( ξ + α ) Δ T \approx - 6.92 \times 1 {0}^{- 6} Δ T \qquad ( 1 )$$

$$Δ {v}_{ε} / v = - ( 1 - {p}_{ε} ) Δ ε \approx - 0.78 Δ ε \qquad ( 2 )$$

where Δv_{T} and Δv_{ε} are the spectral shift induced by temperature change ΔT and strain change Δε, respectively, represents the thermo-optic coefficient of the sensing fiber, α is the thermal expansion coefficient of the sensing fiber, and p_{ε} represents the effective optical expansion coefficient of the sensing fiber 130.

The optical phase φ(z) of the backscattered light (backscattered optical signal) is dependent on the environmental conditions and can also be used for the quantitative measurements. According to an embodiment, which can be combined with any other embodiment described herein, the φOTDR device 100 obtains the phase by coherent detection, which uses a local oscillator to mix with the backscattered light. Different signal processing methods, such as IQ demodulation and analog circuits, can be used to retrieve the phase information from the beat signal between the local oscillator and the backscattered light. Based on the coherent detection, the optical phase profile along an optical fiber can be obtained for every pulse.

The phase information is lost if the backscattered light directly enters a square-law detector. However, the φOTDR device 100 as described herein is configured to obtain the phase information with the help of an interferometric structure, for example a Mach-Zehnder interferometer and a Michelson interferometer. The output of the interferometer can be detected directly. Different signal processing methods can be used to obtain the phase difference Δφ.

The phase actually varies randomly with an environmental change, but the phase difference Δφ between two fiber positions exhibits a quasi-linear relationship with the external variation. The position interval Δl used to obtain the phase difference is usually set uniform along the optical fiber 130. The phase difference obtained at position z and measurement time t can be expressed as

$$Δφ ( z , t ) = 4 π n Δ lv ( t ) / c \qquad ( 3 )$$

where t is time, n is the refractive index of the fiber and c is the light speed in vacuum. During the frequency scan, the optical frequency changes with time.

Environmental temperature variation can change the refractive index and the length of the optical fiber 130, resulting in a change of the phase difference. The temperature induced phase difference change can be expressed as

$${Δφ}_{T} = 4 πγΔ T {l}_{T} v / c + 4 π n η {l}_{T} v / c \qquad ( 4 )$$

where γ is the thermo-optic coefficient of the optical fiber 130, η is the thermal expansion coefficient of the optical fiber 130, l_{T} is equal to the smaller value between the fiber length under the temperature change and the value Δl.

The strain induced phase difference change can be expressed as

$${Δφ}_{ε} \approx 4 π n {l}_{Δ ε} v / c \cdot ( 1 - 0.1 {n}^{2} ) Δ ε \qquad ( 5 )$$

where l_{ΔE} is equal to the smaller value between the fiber length under the strain change and the value Δl.

As shown by Eq. (3), the phase difference is also dependent on the optical frequency v of the pulse. This means the phase difference Δφ changes with the optical frequency even when there is no environmental variation. Thus, the optical frequency change during scanning can be monitored by the phase difference obtained from the reference section 132 of the optical fiber 130 that is well isolated from environmental perturbation. It is beneficial to determine the optical frequency v(t) for interpolation the obtained signal when the optical frequency scanning is not strictly linear. The optical frequency determined during the scanning can also be used in a feedback loop to change the driver signal applied to the light source in order to realize a linear scan. Compared with the absolute optical frequency v, the frequency change v′ relative to a reference time during the scanning, for example beginning of each scan, is more important for the φOTDR sensing method based on the frequency shift of the reflection spectrum. The relative frequency v′ at any time t can be determined by the optical phase difference as

$${v}^{′ ( t )} = [ Δ φ ( t ) - Δ φ ( {t}_{r e f} ) ] c / 4 π n Δ l \qquad ( 6 )$$

where t_{ref} is the reference time. The obtained relative frequency v′ can be averaged over the whole reference fiber to reduce the influence of noise and achieve a more accurate result.

Hence, according to an embodiment, which can be combined with any other embodiment described herein, the relative optical frequency v′ of the injected optical pulses relative to a reference optical frequency during scanning is determined based on the optical signal backscattered from the reference section 132 of the optical fiber 130. Optical pulses are injected at preselected optical frequencies, wherein one of the optical pulses is a reference pulse at a given optical frequency. The relative optical frequency v′ of the injected optical pulses is determined relative to a reference optical frequency, i.e. the given optical frequency of the reference pulse.

Conventional φOTDR devices can only determine either the amplitude/intensity or the optical phase of the backscattered light to realize quantitative measurements. Different thereto, the present disclosure provides for a new φOTDR device 100 and method which can determine both amplitude/intensity and the optical phase, i.e. two characteristics of the backscattered optical signal, and which can therefore reliably evaluate at least two environmental parameters.

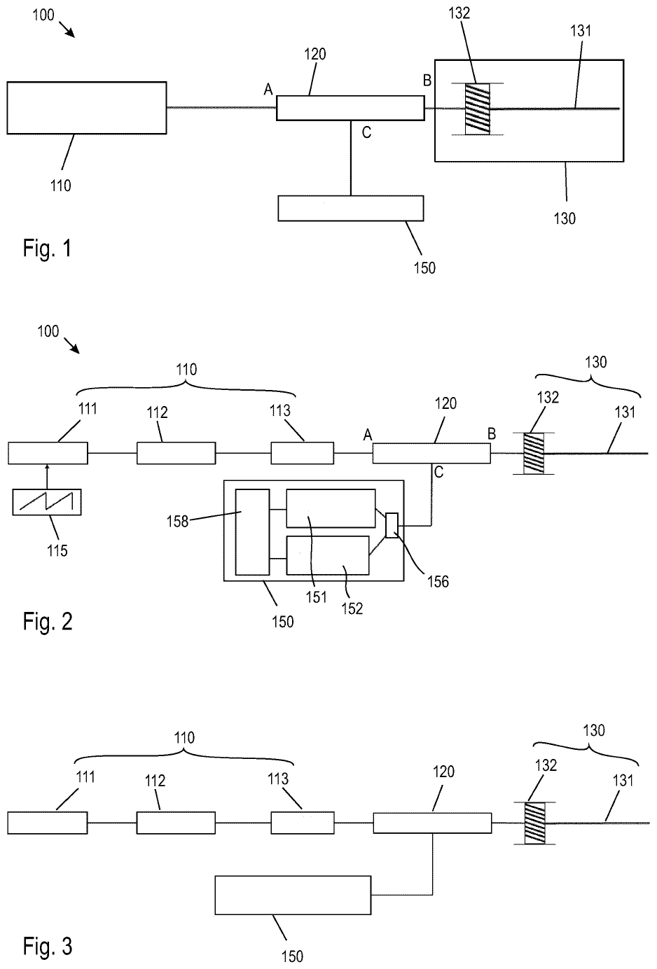

A further example of a φOTDR sensing device 100 according to an embodiment, which can be combined with any other embodiment described herein, is shown in FIG. 2. The device 100 comprises a coherent light source 111, which may be for example a semiconductor distributed feedback laser. A driver 115 supplies a driver signal to the light source 111 to change the working temperature or current of the light source 111 in order to scan the optical frequency of the output of the light source 111. Another option to realize frequency scanning is to use a frequency shifter, such as an electro-optic modulator and an acousto-optic modulator, driven by RF signal with tunable frequency. In this case, the driver signal for the light source 111 is optional as the light source 111 is operated at fixed optical frequency.

The coherent light source 111 may work at any wavelength, but usually in the near infrared range such as between about 780 nm and 3 μm. The linewidth of the light source is usually narrow, in the order of kHz for example.

The device 100 also comprises an optical gate 112 to convert the continuous wave from the light source 111 into optical pulses. The optical gate 112 may be for example an electro-optic modulator, an acousto-optic modulator and a semiconductor optical amplifier.

In a modification, the optical frequency scan and pulse generation can be performed by just an optoelectrical component, for example an electro-optic modulator. In this case, the optical frequency of the light source 111 remains fixed over time. An RF pulse with tunable microwave frequency is applied to the modulator (optical gate 112) so that sidebands are generated in optical frequency domain due to the modulation. The optical sidebands are modulated into pulses because the applied RF signal is pulsed. If more than one sideband is generated, an optical filter can be used to select one of the generated sidebands, which is the optical pulse with scanned frequency.

After the pulse conversion, an optical amplifier 113 may be used in the device 100 to amplify the pulse to a required level. For example, an erbium doped fiber amplifier may be used as optical amplifier 113.

The coherent light source 111, the optical gate 112, the optical amplifier 113 and the driver 115 may be part of the frequency-scanning optical pulse generator 110. Hence, according to an embodiment which can be combined with any other embodiment described herein, the frequency-scanning optical pulse generator 110 is configured to scan the frequency of the optical pulses through a predetermined optical frequency range. Moreover, according to an embodiment which can be combined with any other embodiment described herein, the frequency-scanning optical pulse generator 110 can comprises a light source 111 driven by an electric signal for optical frequency scanning and an optical gate 112 for optical pulse generation.

The output of the frequency-scanning optical pulse generator 110, in the present embodiment the output of the optical amplifier 113, is coupled with the optical element 120. The optical element 120 has, in the present embodiment, three ports. One port, marked as port A, is coupled with the frequency-scanning optical pulse generator 110, another port, marked as port B, is coupled with the optical fiber 130, and a further port, marked as port C, is coupled with the receiver module. Light received at port A is directed to port B only while light received at port B is directed to port C only. No light enters port C.

Each pulse of the sequences of pulses is injected into the optical fiber 130, which comprises the reference section 132 and the sensing section 131, via the optical component 120. The optical component 120 also redirects the backscattered light, i.e. the backscattered optical signal, from the optical fiber 130 into the receiver module 150. In the receiver module 150, the backscattered light may be split by a splitter 156, and the optical split signals generated by the splitter 156 are directed to a submodule 151 for determining amplitude and/or intensity information of the backscattered optical signal and a submodule 152 for determining phase information of the backscattered optical signal.

Amplitude and/or intensity information refers to a value or values which represents/represent the amplitude and/or intensity of the backscattered light representative for a given location (position) in the fiber 130 when coherent detection is used to obtain the backscattered light. If an interferometer is used and the output of the interferometer is detected directly, the amplitude information refers to a value that is obtained as the amplitude in IQ demodulation process, which is proportional to the product of the amplitude of the light backscattered at two different positions. The intensity information is the square of the amplitude in this case. On the other hand, phase information refers to a value which represents the phase or a phase difference of the backscattered light representative for a given location (position) in the fiber 130.

Another example for a φOTDR sensing device 100 according to an embodiment, which can be combined with any other embodiment described herein, is shown in FIG. 3, which employs a single submodule within the receiver module 150 for both determining amplitude and/or intensity information of the backscattered optical signal and phase information of the backscattered optical signal.

The receiver module 150 may therefore comprise two submodules, one submodule 151 for determining amplitude and/or intensity information of the backscattered optical signal and another submodule 152 for determining phase information of the backscattered optical signal, or a single submodule 152 for both determining amplitude and/or intensity information of the backscattered optical signal and phase information of the backscattered optical signal.

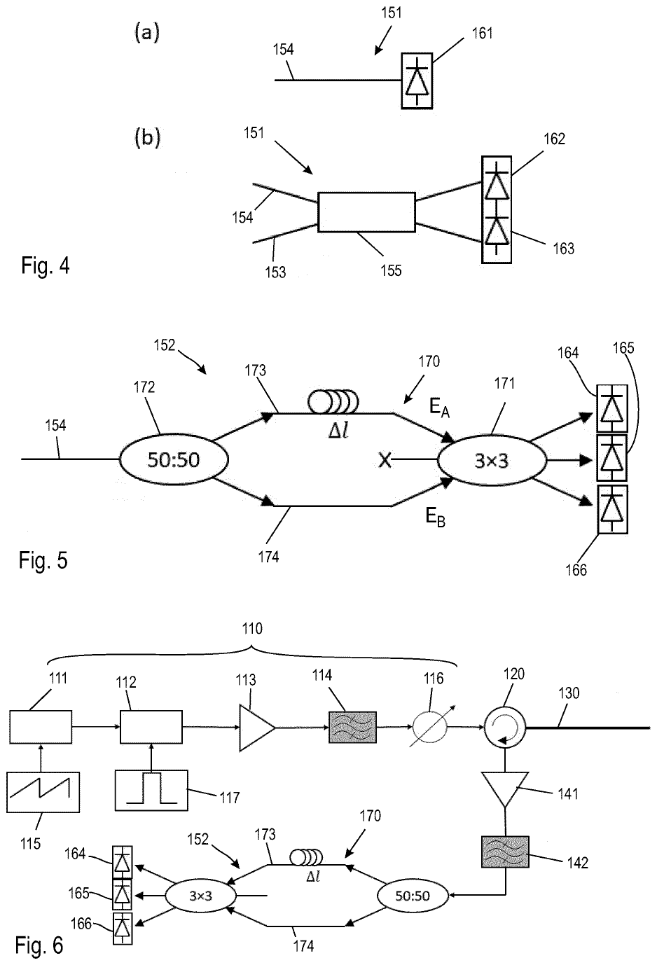

FIG. 4(a) show a schematic illustration of the submodule 151 for determining amplitude and/or intensity information based on direct detection. The optical split signal 154 generated by the splitter 156 from the backscattered optical signal directly enters a photo detector 161. The output of the photo detector 161 provides the information on the amplitude and/or intensity of the backscattered light.

Another possible scheme for the submodule 151 for determining amplitude and/or intensity information is based on coherent detection as shown in FIG. 4(b). The optical split signal 154 generated by the splitter 156 and light 153 of a local oscillator, operated at fixed frequency, are combined by a coupler 155. The output of the coupler 155 is directed to a detector, which comprises two photo detectors 162, 163 in a balanced configuration. The output of the balanced detector provides the beat signal between the backscattered light 154 and the light 153 of the local oscillator.

The output of the submodule 151 for amplitude/intensity detection is processed by a data processing device 158 using cross-correlation or other methods to obtain the spectral shift Δv along the reference section 132 and the sensing section 131. The environmental change can then be quantified based on the obtained shift Δv for the low frequency and even quasi-static measurement.

FIG. 5 is a schematic illustration of a possible submodule 152 for determining phase information. The backscattered light 154 is split by a splitter 172 and passes through a first arm 173 and a second arm 174 of a Mach-Zehnder interferometer 170. The first arm 173 and the second arm 174 are directed to two inputs of a [3×3] coupler 171 so that the light passing through the two arms 173, 174 is coupled and interferes at the [3×3] coupler 171. The third input of the [3×3] coupler 171 is unused and can be blocked. The [3×3] coupler 171 does not only split the incident light evenly into three outputs, but also introduces 120° phase shift between the outputs. The length of the first arm 173 is different from the length of the second arm 174. For example, the first arm 173 in FIG. 5 is longer so the light traveling along this path is delayed relative to the light in the second arm 174. Therefore, the interference result of the light travelling along the two arms 173, 174 of the interferometer 170 is dependent on the phase difference of reflected light from two locations (positions) within the fiber having a distance which is equivalent to the length difference of the two arms 173, 174. The length difference between the first arm 173 and the second arm 174, expressed as Δl in Eq. (3), is approximately equal to or larger than the length of the optical pulse. Note that the Mach-Zehnder interferometer 170 shown in FIG. 5 is just an example, other interferometer structures, such as Michelson interferometer, can also realize the same functionality.

The outputs of the submodule 152 for phase retrieval can be processed in a way to obtain the phase difference Δφ. For example, a differential and cross-multiply demodulation method can be used to obtain the phase difference Δφ along the reference and the sensing section 131. The phase difference may be used to quantify any environmental change. For coherent detection, the optical phase along the fiber is first obtained, then the difference is calculated. For direct detection based on interferometers, the phase difference can be directly computed.

Another method is to process the output of the interferometer P₁(z), P₂(z), P₃(z) as

$$\{ \begin{matrix}I ( z ) = - {P}_{1} ( z ) / 2 + {P}_{2} ( z ) - {P}_{3} ( z ) / 2 \\ Q ( z ) = - \sqrt{3} {P}_{1} ( z ) / 2 + \sqrt{3} {P}_{3} ( z ) / 2\end{matrix} \qquad ( 7 )$$

wherein P₁(z), P₂(z), P₃(z) denote the signals obtained and produced by the photo detectors 164, 165 and 166, respectively.

The first arm 173 of the interferometer 170 is longer than the second arm 174 by a length of Δl, which can be considered as the gauge length of the sensor. The light passing through the first arm 173 is delayed, so the optical signals that appear at the same time at the inputs of the [3×3] coupler can be written as

$${E}_{A} = \frac{1}{\sqrt{2}} E ( z ) {e}^{\frac{j 2 π}{λ} \cdot Δ l} and {E}_{B} = \frac{1}{\sqrt{2}} E ( z + Δ l ) {e}^{\frac{j π}{2}} ,$$

where E(z) represents the optical field of the backscattered optical signal at the position z which contains amplitude and phase information, λ represents the wavelength, and the coefficient √½ and the π/2-phase shift in E_{B} are induced by the splitter 172.

The three optical outputs of the interferometer 170 are given by

$$\{ \begin{matrix}{E}_{1} = \frac{1}{\sqrt{3}} \cdot ( {E}_{A} + {E}_{B} {e}^{j 2 π / 3} ) \\ {E}_{2} = \frac{1}{\sqrt{3}} \cdot ( {E}_{A} {e}^{j 2 π / 3} + {E}_{B} {e}^{j 2 π / 3} ) \\ {E}_{3} = \frac{1}{\sqrt{3}} \cdot ( {E}_{A} {e}^{j 2 π / 3} + {E}_{B} )\end{matrix} \qquad ( 8 )$$

Since Pᵢ=EᵢE*ᵢ, the above can be rewritten to:

$$\{ \begin{matrix}{P}_{1} ( z ) = {P}_{D C} ( z ) - {P}_{A C} ( z ) sin [ Δφ ( z ) + 2 π / 3 ] \\ {P}_{2} ( z ) = {P}_{D C} ( z ) - {P}_{A C} ( z ) sin Δ φ ( z ) \\ {P}_{3} ( z ) = {P}_{D C} ( z ) - {P}_{A C} ( z ) sin [ Δ φ ( z ) - 2 π / 3 ]\end{matrix} \qquad ( 9 )$$

with Δφ=φ(z+Δl)−φ(z) −2π·Δl/λ being the phase difference between the fiber position z and z+Δl, P_{DC}=[P(z)+P[z+Δl)]/6, and P_{AC}=|E(z)∥E(z+Δl)|/3 with |E(z)| representing the field amplitude of the backscattered optical signal at the position z. The term 2π·Δl/λ included by the delay of the first arm 173 can be considered as a constant so it is neglected during the calculation.

Then the amplitude information A_{de}(z) and the phase difference can be computed as

$${A}_{de} ( z ) ∝ \sqrt{{I}^{2} ( z ) + {Q}^{2} ( z )} \qquad ( 10 )$$

$$Δ φ ( z ) = {tan}^{- 1} [ I ( z ) / Q ( z ) ] + 2 k π$$

where k is an integer and the term 2kπ represents a phase unwrapping process to expand the value of the tan⁻¹ function. The phase unwrapping process is usually necessary because the result obtained by the tan⁻¹ function is limited within [−π/2, π/2], which may be different from the actual phase difference value. A phase unwrapping process is able to expand the result of the tan⁻¹ function so that the correct phase difference is obtained.

The obtained phase difference changes during the frequency scan as shown by Eq. (3). The influence of the frequency scanning on the phase difference can be easily removed by frequency filtering. For example, a notch filter can be used to suppress the phase difference at the scanning frequency. High frequency measurement can be realized based on the obtained phase difference. The environmental variation can be quantified based on the filtered phase difference.

The configuration of the submodule 152 shown in FIG. 5 can also be used as the single submodule for both phase and amplitude/intensity detection 150 in the configuration shown in FIG. 3. The phase difference can be obtained as described above. The spectral shift is determined based on the amplitude information A_{de}(z) obtained by Eq. (10). The obtained signal A_{de}(z) is basically proportional to the product of A(z) and A(z+Δl) of the backscattered light, therefore, A_{de}(z) is equivalent to the product of the reflection spectra at two different positions z and z+Δl. The two spectra can be considered as independent if the two positions with an interval that is longer than the pulse length. As a result, the spectral shift can also be obtained from the amplitude information A_{de}(z) for the low frequency measurement.

The receiver module 150 can comprise the submodule 152 shown in FIG. 5 in combination with one of the submodules 151 shown in FIG. 4(a) or FIG. 4(b), or can alternatively comprise only the submodule 152 shown in FIG. 5 as the submodule 152 allows to determine both the amplitude/intensity and the phase based on the evaluation of the signals of the photo detectors 164, 165, 166 as described above. Using one of the submodules 151 in addition to the submodule 152 provides for a more direct detection of the amplitude/intensity and can reduce the data processing of the data processing device 158. It also allows to select only one submodule if only one environmental parameter is of interest or shall be detected.

The data processing device 158 receives the electrical signals of the photo detectors, which may also be preprocessed, and performs the calculations as described herein. The data processing device 158 may include AD converters to generate digital values which are used by a computer as input for the calculation.

Based on the sensing device as depicted in FIG. 1 to FIG. 6, both the spectral shift Δv and the phase difference Δφ can be simultaneously determined. The spectral shift can be used to measure the environmental change at low frequency range whereas the phase difference can be used for the high frequency sensing. In addition, the phase difference obtained at the reference fiber section can also be used to determine the relative frequency change during scanning, as shown by Eq. (6).

Both the spectral shift Δv and the phase difference Δφ are sensitive to temperature and strain change, so an equation system can be built as

$$\{ \begin{matrix}Δ v ( z ) = {K}_{v , T} Δ T + {K}_{v , ε} Δ ε \\ Δφ ( z ) = {K}_{φ , T} Δ T + {K}_{φ , ε} Δ ε\end{matrix} \qquad ( 11 )$$

where K_{v,T} and K_{v,ε} respectively represents the temperature and strain sensitivities for the reflection spectrum, and K_{φ,T} and K_{φ, ε} respectively represents the temperature and strain sensitivities for the optical phase. As a result, the temperature and strain changes can be simultaneously obtained along the sensing fiber by the spectral shift Δv and the phase difference Δφ as

$$\{ \begin{matrix}Δ T ( z ) = \frac{{K}_{φ , ε} Δ v ( z ) - {K}_{v , ε} Δφ ( z )}{{K}_{v , ε} {K}_{φ , T} - {K}_{φ , ε} {K}_{v , T}} \\ Δ ε ( z ) = \frac{{K}_{φ , T} Δ v ( z ) - {K}_{v , T} Δφ ( z )}{{K}_{v , ε} {K}_{φ , T} - {K}_{φ , ε} {K}_{v , T}}\end{matrix} \qquad ( 12 )$$

Three photo detectors 164, 165, 166 are used as shown in FIG. 5, which increases the amount of the obtained data, because a standard φOTDR device usually employs only one photo detector. However, the use of the three photo detectors 164, 165, 166 also improves reliability of the phase and amplitude/intensity determination.

According to an embodiment which can be combined with any other embodiment described herein, the number of the photo detectors used in FIG. 5 can be reduced. As shown by Eq. (7), the quadrature component Q is proportional to the signal difference of two outputs. Thus, only two photo detectors can be used to obtain the signal from arbitrary two outputs of the [3×3] coupler 171 and the signal difference between the two used photo detectors is considered as the quadrature component Q. Or arbitrary two outputs of the [3×3] coupler 171 can be directly connected to two inputs of a balanced photo detector, which provides the signal difference directly. Once the quadrature component is determined, the in-phase component can be computed as the Hilbert transform of Q, so that the amplitude information A_{de}(z) and the phase difference can be calculated by Eq. (10). It has to be noted that the obtained phase difference may possess an offset of ±2π/3, depending on the choice of the [3×3] coupler outputs. This phase offset is a constant and can be easily removed for dynamic measurement. If a single balanced photo detector or two photo detectors is or are used, the amount of detected data is reduced compared with the case of three photo detectors, facilitating data storage, data processing and data transmission.

An experimental setup of the sensing device shown in FIG. 6 is used to demonstrate an embodiment of the invention. The used light source 111 is a semiconductor laser working at 1550 nm with a narrow linewidth of 3 kHz. The optical frequency of the laser is modulated by a ramp signal (driver signal) at 50 Hz, provided by the driver 115, to realize frequency scanning. A semiconductor optical amplifier 112, receiving a driver signal from a driver 117, is used to convert the light from the laser 111 into optical pulses. Note, the optical gate can also be implemented by the semiconductor optical amplifier 112. The pulse width is set to 10 ns and the pulse repetition rate is set to 20 kHz.

The generated pulses are amplified by an erbium-doped fiber amplifier (EDFA) 113. A narrowband filter 114 of ±12.5 GHz bandwidth is used to suppress the amplified spontaneous emission from the EDFA, and an optional attenuator 116 may be used to adapt the intensity of the pulses. Then the optical pulses are launched into a fiber under test 130 via a circulator 120 which is the optical element here. The circulator 120 also redirects the weak backscattered light into another EDFA (optical amplifier 141) for pre-amplification, and another filter 142 is used to suppress amplified spontaneous emission (ASE). Then the amplified light enters the submodule 152 for both determining amplitude and/or intensity information of the backscattered optical signal and phase information. The submodule 152 includes a Mach-Zehnder interferometer as shown in FIG. 5. The length difference of the two arms 173, 174 in the interferometer 170 is set to 2 m. Three photo detectors 164, 165, 166 with very similar performance are employed to acquire outputs of the interferometer 170.

The fiber 130 is about 1450 m long, the first 400 m of the fiber 130 forms a reference section 132 that is well isolated in a box, which can be used to measurement the relative frequency change of the light source 111. The rest of the fiber 130 is placed in the open air, acting as the sensing section 131. A short part of the sensing section 131 of about 10 m is wrapped around a piezoelectric tube (PZT) for vibration measurement. A sinusoid voltage is applied to the PZT so that the fiber wrapped around is stretched accordingly. The vibration frequency of the PZT is set to 2 Hz and 1 kHz for low frequency and high frequency measurements, respectively.

The output of the photo detectors 164, 165, 166 is digitalized at a rate of 250 MS/s and the digitalized signal is processed by a computer (data processing device 158). The amplitude obtained by Eq. (7) and (10) is used to build the reflection spectrum at each position along the whole fiber 130. Then spectral shift can be obtained by cross-correlation of the reflection spectra and used to quantify the environmental change at a low frequency, which is half of the ramp frequency (25 Hz in this case).

The phase difference can also be computed by Eq. (7) and (10) based on the digitalized signal. The phase difference obtained in the reference section 132 of the fiber 130 is used to calculate the relative frequency shift of the light source 111, the phase difference obtained in the sensing section 131 of the fiber 130 is used for the quantification of the environmental change at a high frequency, which is half of the pulse repetition rate (10 kHz in this case).

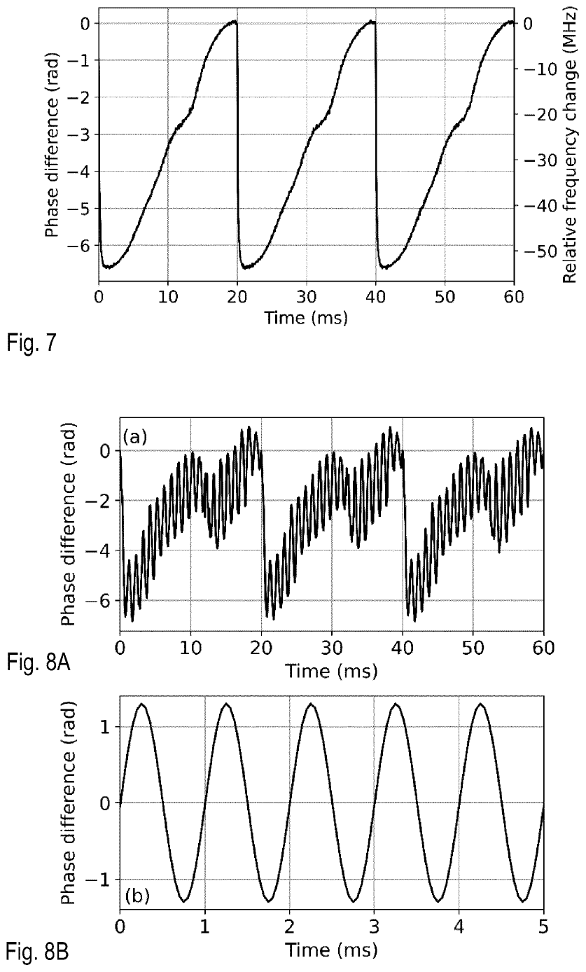

FIG. 7 shows the phase difference obtained at a given position in the reference section 132. The phase difference changes at a period of 20 ms due to the ramp signal applied to the laser 111. The relative optical frequency change can be calculated according to Eq. (6) based on this phase difference, which is shown by the y-axis at the right-hand side of FIG. 7. Therefore, the relative optical frequency change can be used to monitor each frequency scan and help determine the spectral shift.

FIG. 8 shows the phase difference obtained at 1407.65 m that is subject to the 1 kHz vibration of the PZT. The temporal shape shown in FIG. 8(a) is a combination of a quasi-ramp wave at 50 Hz and a sinusoid wave at 1 kHz, which are caused by the frequency scanning and the applied vibration, respectively. The two oscillating signals can be separated in frequency domain. Since the laser scanning frequency is known, signals at this frequency can be easily removed by notch filtering. The filtering result exhibits a sinusoid waveform at 1 kHz as shown in FIG. 8(b), demonstrating this invention is able to realize dynamic measurement at high frequency based on the phase difference.

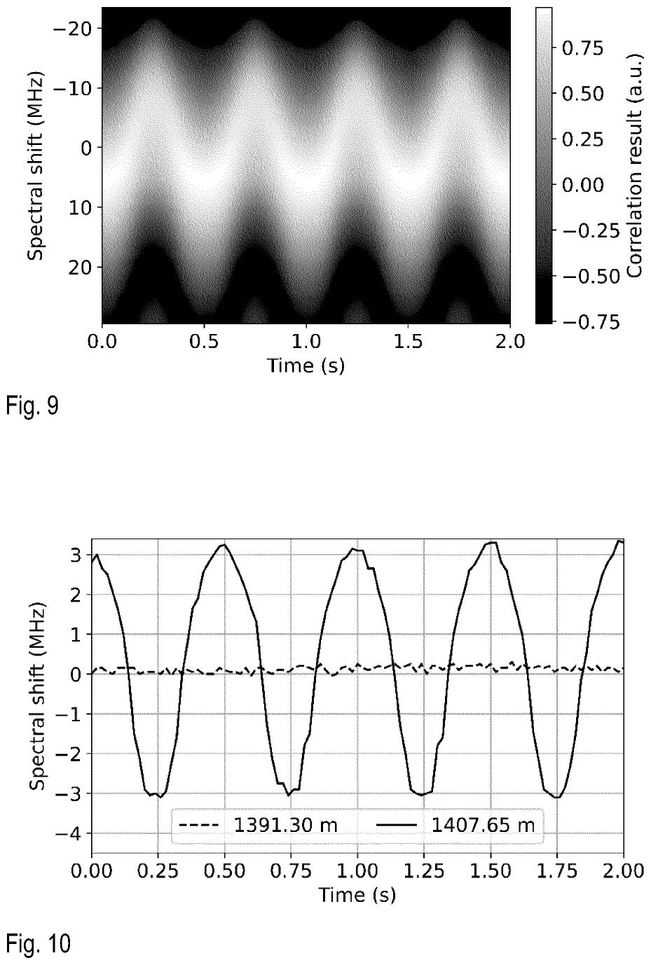

The vibration frequency of the PZT is set to 2 Hz for the low frequency measurement. Based on the obtained relative optical frequency change, the reflection spectrum is interpolated at each position along the fiber 130. FIG. 9 shows the cross-correlation result between the reflection spectrum obtained at the first scan and later at fiber position 1407.65 m. The position of the correlation peak in the frequency domain manifests the corresponding spectral shift.

FIG. 10 shows the temporal change of the spectral shifts obtained at two different fiber positions. The spectral shift obtained at 1407.65 m fiber exhibits a clear oscillation at 2 Hz because the fiber at this position is subject to the 2 Hz vibration. The spectral shift at 1391.30 m, an unperturbed position, varies slightly around 0 MHz, indicating there is no environmental change.

### REFERENCE SIGNS

100 device
110 frequency-scanning optical pulse generator
111 coherent light source/laser
112 optical gate
113 optical amplifier
114 optical filter
115 driver for coherent light source
116 attenuator
117 driver for optical gate
120 optical component/circulator
130 optical fiber
131 sensing section
132 reference section
141 optical amplifier
142 optical filter
150 receiver module
151 submodule for determining amplitude and/or intensity information
152 submodule for determining phase information
153 light from local oscillator
154 backscattered light/backscattered optical signal
155 coupler
156 splitter
158 data processing device
161, 162, 163 photo detector
170 interferometer
171 [3×3] coupler
172 splitter
173 first arm of interferometer
174 second arm of interferometer

1. A device for quantifying a change in environmental conditions along the length of an optical fiber, comprising:
a frequency-scanning optical pulse generator configured to generate pulse sequences of optical pulses with variable optical frequencies;
an optical component coupled with the frequency-scanning optical pulse generator for injecting the optical pulses into an optical fiber and for redirecting the backscattered optical signal from the optical fiber; and
a receiver module coupled with the optical component, the receiver module including
an interferometer and photo detectors, the interferometer having an input for receiving the backscattered optical signal and a coupler for providing optical signal outputs with shifted phases, wherein each optical signal output of the coupler is coupled with one of the photo detectors for providing electrical signals; and
a data processing device coupled with the photo detectors for receiving the electrical signals, the data processing device being configured to derive phase information of the backscattered optical signal from the electrical signals as a function of time and optical frequency.

2. The device according to claim 1, wherein the data processing device being configured to derive, in addition to phase information, amplitude and/or intensity information of the backscattered optical signal from the electrical signals as a function of time and optical frequency.

3. The device according to claim 1, wherein the frequency-scanning optical pulse generator is configured to periodically scan the optical frequency of the optical pulses through a predetermined optical frequency range.

4. The device according to any of claim 1, wherein the frequency-scanning optical pulse generator comprises a coherent light source configured to receive an electric driver signal which causes the light source to perform optical frequency scanning, and an optical gate configured to receive light from the light source and to generate optical pulses.

5. The device according to claim 1, wherein the frequency-scanning optical pulse generator comprises a coherent light source configured to operate at a fixed optical frequency, a modulator configured to be driven by a RF signal with a scanned microwave frequency and an optional narrow filter to select one sideband after the modulation for optical frequency scanning, and an optical gate for optical pulse generation.

6. The device according to claim 1, wherein the frequency-scanning optical pulse generator comprises a coherent light source configured to operate at a fixed optical frequency, a modulator configured to be driven by a RF pulse signal and an optional narrow filter to select one sideband after the modulation for optical frequency scanning.

7. The device according to claim 1, wherein the receiver module is configured to determine the relative optical frequency v′ of the injected optical pulses relative to a reference optical frequency during scanning based on the optical signal backscattered from a reference section of the optical fiber.

8. The device according to claim 1, wherein the receiver module is configured to obtain reflection spectra for a given position in the optical fiber based on sequences of pulses, wherein the receiver module is further configured to detect a frequency shift of the reflection spectra to acquire local environmental information.

9. The device according to claim 1, wherein the interferometer comprises two arms with different path lengths, wherein the difference between the two arms is equal to or larger than the length of an optical pulse.

10. The device according to claim 1, wherein the receiver module comprises a splitter for splitting the backscattered optical signal into two optical split signals, a submodule for determining amplitude and/or intensity information of the backscattered optical signal and a submodule for determining phase information of the backscattered optical signal, wherein the submodule for determining amplitude and/or intensity information is coupled with the splitter to receive one optical split signal of the backscattered optical signal and the submodule for determining phase information is coupled with the splitter to receive the other optical split signal of the backscattered optical signal.

11. The device according to claim 10, wherein the submodule for determining amplitude and/or intensity information comprises a coupler for mixing the optical split signal with a local oscillator and a balanced detector for detecting the output of the coupler.

12. The device according to claim 10, wherein the submodule for determining phase information comprises the interferometer and the photo detectors for detecting the output of the interferometer.

13. The device according to claim 1, wherein
the interferometer comprises a first arm and a second arm, wherein the first arm has a longer optical path than the second arm, and
wherein the coupler is a [3×3] coupler which is configured to output three optical signals with shifted phases of 120°, wherein the first arm and the second arm are coupled with respective inputs of the [3×3] coupler, wherein each optical signal output of the [3×3] coupler is coupled with one of the photo detectors for providing the electrical signals.

14. The device according to claim 13, wherein the phase difference Δφ along the reference section and a sensing section of the optical fiber and the amplitude information A_{de}(z) is determined according to
$$\{ \begin{matrix}I ( z ) = - {P}_{1} ( z ) / 2 + {P}_{2} ( z ) - {P}_{3} ( z ) / 2 \\ Q ( z ) = - \sqrt{3} {P}_{1} ( z ) / 2 + \sqrt{3} {P}_{3} ( z ) / 2\end{matrix} \qquad ( 7 )$$
$$and$$
$${A}_{d e} ( z ) ∝ \sqrt{{I}^{2} ( z ) + {Q}^{2} ( z )} \qquad ( 10 )$$
$$Δφ ( z ) = {tan}^{- 1} [ I ( z ) / Q ( z ) ] + 2 k π$$
wherein P₁(z), P₂(z), and P₃(z) denote the signals obtained and produced by the photo detectors, respectively, and wherein k is an integer and the term 2kπ represents a phase unwrapping process to expand the value of the tan⁻¹ function.

15. A system for quantifying a change in environmental conditions along the length of an optical fiber, comprising:
a device for quantifying a change in environmental conditions along the length of an optical fiber, the device including:
a frequency-scanning optical pulse generator configured to generate pulse sequences of optical pulses with variable optical frequencies;
an optical component coupled with the frequency-scanning optical pulse generator for injecting the optical pulses into an optical fiber and for redirecting the backscattered optical signal from the optical fiber; and
a receiver module coupled with the optical component, the receiver module including
an interferometer and photo detectors, the interferometer having an input for receiving the backscattered optical signal and a coupler for providing optical signal outputs with shifted phases, wherein each optical signal output of the coupler is coupled with one of the photo detectors for providing electrical signals; and
a data processing device coupled with the photo detectors for receiving the electrical signals, the data processing device being configured to derive phase information of the backscattered optical signal from the electrical signals as a function of time and optical frequency, and
an optical fiber coupled with the optical component of the device.

16. The system according to claim 15, wherein the optical fiber comprises a reference section that is isolated from environmental perturbations and a sensing section.

17. A method for determining changes of parameters of interest along an optical fiber for low and high frequency measurement, the method comprising the steps of:
providing optical pulses of different optical frequencies;
injecting the optical pulses into an optical fiber;
receiving an optical signal Rayleigh backscattered from the optical fiber;
splitting the optical signal into two optical split signals;
detecting one of the two optical split signals as intensity of the backscattered optical signal as a function of time to obtain reflection spectra along the optical fiber;
introducing the other of the two optical signals into an interferometer and detecting the output of the interferometer as a phase of the optical signal backscattered from the optical fiber as a function of time; and
calculating a spectral frequency based on correlation of the reflection spectrum along the optical fiber for low frequency measurement and a phase difference based on the output of the interferometer for high frequency measurement.

18-21. (canceled)

22. The device according to claim 1, wherein the frequency-scanning optical pulse generator is configured to generate pulse sequences of optical pulses with variable optical frequencies, wherein each pulse sequence includes a plurality of pulses with increasing or decreasing optical frequency.

23. The method according to claim 17, wherein providing optical pulses of different optical frequencies comprises generating pulse sequences of optical pulses with variable optical frequencies, wherein each pulse sequence includes a plurality of pulses with increasing or decreasing optical frequency.
